(19) United States
(12) Patent Application Publication
(10) Pub. No.: US 2026/0141237 A1
(43) Pub. Date: May 21, 2026

(54) APPARATUS AND METHOD FOR PROCESSING MULTIVARIATE TIME-SERIES SENSOR DATA, AND METHOD FOR TRAINING ARTIFICIAL NEURAL NETWORK FOR PROCESSING MULTIVARIATE TIME-SERIES SENSOR DATA

(71) Applicant: RESEARCH & BUSINESS FOUNDATION SUNGKYUNKWAN UNIVERSITY, Suwon-si (KR)

(72) Inventors: Hogun PARK, Suwon-si (KR); Heesoo JUNG, Suwon-si (KR); Jaehyun BAE, Suwon-si (KR)

(21) Appl. No.: 19/389,838

(22) Filed: Nov. 14, 2025

(30) Foreign Application Priority Data
Nov. 15, 2024 (KR) 10-2024-0163516

(51) Int. Cl. G06N 3/08; G06N 3/0442

(52) U.S. Cl. CPC G06N 3/08; G06N 3/0442

(57) ABSTRACT

An apparatus comprises: an acquisition unit acquiring the multivariate time-series sensor data and classifying the multivariate time-series sensor data into source domain data and target domain data; a memory including instructions for extracting features of a source spatial structure and features of a target spatial structure from the source domain data and the target domain data using a pre-trained artificial neural network; and a processor, by executing the instructions, classifying the source domain data based on the features of the source spatial structure and classifying the target domain data based on the features of the target spatial structure. The artificial neural network is pre-trained to dynamically generate an adjacency graph between the source domain data and the target domain data and the target spatial structure, and is pre-trained such that a distribution of the target domain data approaches a distribution of the source domain data based on the adjacency graph.

### CROSS-REFERENCE TO RELATED APPLICATION

This application claims priority to Korean Patent Application No. 10-2024-0163516, filed on Nov. 15, 2024, the entirety of which is incorporated herein by reference for all purposes.

### TECHNICAL FIELD

An embodiment of the present invention relates to a technology for processing multivariate time-series (hereinafter, MTS) sensor data and to the training of an artificial neural network for this purpose.

This work was supported by Korea Creative Content Agency grant funded by the Korea government (Ministry of Culture, Sports and Tourism) (Project unique No.: 2370000050; Project No.: 00333068; R&D project: Leading copyright technology development; Research Project Title: Development of technology for dataset copyright of multimodal generative AI model; and Project period: 2024 Apr. 1˜2026 Dec. 31), Korea government (Ministry of Culture, Sports and Tourism) (Project unique No.: 2370000314; Project No.: 00348469; R&D project: Leading copyright technology development; Research Project Title: Research on neural watermark technology for copyright protection of generative AI 3D content; and Project period: 2024 Apr. 1˜2026 Dec. 31), National Research Foundation of Korea (NRF) grant funded by the Korean government (Ministry of Science and ICT) (Project unique No.: 2710018181; Project No.: 00448809; R&D project: Nanomaterial technology development; Research Project Title: Hazardous substance monitoring platform development using AIoT/IoT optical device gas sensor based on color conversion nanoparticles; and Project period: 2024 Jul. 1˜2024 Dec. 31), Institute of Information & communications Technology Planning & Evaluation (IITP) grant funded by the Korean government (Ministry of Science and ICT) (Project unique No.: 2710008857; Project No.: RS-2024-00436936; R&D project: Information, Communication, and Broadcasting Innovation Talent Development (R&D); Research Project Title: D² (Disinformation & Deepfake) Research Center; and Project period: 2024 Jul. 1˜2031 Dec. 31), Institute of Information & communications Technology Planning & Evaluation (IITP) grant funded by the Korean government (Ministry of Science and ICT) (Project unique No.: 2710008244; Project No.: 00360227; R&D project: Cultivating AI leaders; Research Project Title: Developing Multimodal Generative AI Talent for Industrial Convergence; and Project period: 2024 Apr. 1˜2027 Dec. 31), National Research Foundation of Korea (NRF) grant funded by the Korean government (Ministry of Science and ICT) (Project unique No.: 2710010292; Project No.: 2021M3H4A1A02056037; R&D project: Nanomaterial technology development; Research Project Title: Development of stress visualization and quantization based on strain sensitive smart polymer for building structure durability examination platform; and Project period: 2021 Apr. 1˜2025 Dec. 31), Institute of Information & communications Technology Planning & Evaluation (IITP) grant funded by the Korean government (Ministry of Science and ICT) (Project unique No.: 2710088567; Project No.: 25442569; R&D project: AI Star Fellowship Support; Research Project Title: AI Star Fellowship Support Program (Sungkyunkwan Univ.); and Project period: 2025 Jul. 1˜2030 Dec. 31), Institute of Information & communications Technology Planning & Evaluation (IITP) grant funded by the Korean government (Ministry of Science and ICT) (Project unique No.: 2710008628; Project No.: 2019-0-00421; R&D project: Information, Communication, and Broadcasting Innovation Talent Development (R&D); Research Project Title: Artificial Intelligence Graduate School Support (Sungkyunkwan University); and Project period: 2024 Jan. 1˜2024 Dec. 31), and Institute of Information & communications Technology Planning & Evaluation (IITP) grant funded by the Korean government (Ministry of Science and ICT) (Project unique No.: 2710007880; Project No.: 11201821; R&D project: Digital Technology Leading Core Talent Development (R&D); Research Project Title: ICT Creative Consilience Program Grant; and Project period: 2024 Jan. 1˜2024 Dec. 31).

### BACKGROUND

Due to its complex spatio-temporal characteristics, MTS data often exhibit a unique data distribution depending on the domain.

Herein, a domain may refer to a specific subject or a specific repetition, depending on its definition. This characteristic of MTS sensor data may cause problems due to differences in data distribution between the domain of data used in the training process (source domain) and the domain of data used in an actual application (target domain).

For example, if the data distribution difference between subject 1 and subject 2 is severe, a model trained only with the data of subject 1 may not show high performance when applied to the data of subject 2.

To solve this problem, an unsupervised domain adaptation (UDA) technique that performs model training without using labels from a target domain has been proposed. The unsupervised domain adaptation technique aims to extract domain-invariant information and to regularize the model to prevent overfitting to the distribution of the source data/domain used during the training process.

However, conventional unsupervised domain adaptation techniques tend to overlook the spatial dependency between multiple sensors, which is one of the characteristics of MTS data, and treat multiple sensors as a single sensor. Even in cases that consider the sensor structure, it is difficult to capture complex inter-domain sensor relationships because they approach the relationship from a fixed perspective of one-to-one mapping of the same sensors. In multi-sensor time-series data, the sensor structure is a crucial factor affecting shifts in data distribution; therefore, it is necessary to accurately consider the inter-domain relationship when applying a domain adaptation technique for such data.

The above-described background art is technical information that the inventor possessed to derive embodiments of the present invention or acquired in the course of deriving embodiments of the present invention, and is not necessarily public knowledge disclosed to the public before the filing of the present invention.

### SUMMARY

An embodiment of the present invention proposes an MTS sensor data processing technology capable of dynamically generating an adjacency graph of MTS sensor data.

An embodiment of the present invention proposes an MTS sensor data processing technology capable of adjusting a distribution of target domain data to approach a distribution of source domain data by dynamically considering a complex sensor relationship between source domain data and target domain data using an adjacency graph generation model and a loss function.

The problems to be solved by embodiments of the present invention are not limited to those mentioned above, and other unsolved problems will be clearly understood by those of ordinary skill in the art from the following descriptions.

According to an embodiment of the present invention, a multivariate time-series sensor data processing apparatus is provided, the apparatus comprising: an acquisition unit configured to acquire multivariate time-series sensor data and to classify the multivariate time-series sensor data into source domain data and target domain data; a memory including instructions for extracting features of a source spatial structure and features of a target spatial structure from the source domain data and the target domain data using a pre-trained artificial neural network; and a processor configured to, by executing the instructions, classify the source domain data based on the features of the source spatial structure and classify the target domain data based on the features of the target spatial structure; wherein the artificial neural network is pre-trained to dynamically generate an adjacency graph between the source domain data and the target domain data and the target spatial structure, and is pre-trained such that the distribution of the target domain data approaches the distribution of the source domain data based on the adjacency graph.

Herein, the artificial neural network may include: an adjacency graph generation model pre-trained to generate the source spatial structure and the target spatial structure using the source domain data and the target domain data as input, and to generate the adjacency graph using adjacency matrices of the source spatial structure and the target spatial structure; and a feature extraction model pre-trained to extract features of the source spatial structure and features of the target spatial structure using a spatial layer and a temporal layer to learn spatial information and temporal information of the multivariate time-series sensor data.

In addition, the artificial neural network may be pre-trained such that a distribution of the target domain data is made to approach a distribution of the source domain data through a matrix multiplication of the adjacency graph and the target domain data.

In addition, the source domain data may include labeled data, and the target domain data may not include labeled data.

In addition, the processor may classify the source domain data to calculate a first loss function that uses the labeled data based on the features of the source spatial structure.

In addition, the processor may classify the target domain data to calculate a second loss function that uses pseudo-labeled data based on the features of the target spatial structure.

In addition, the processor may calculate a distance matrix between the source domain data and the target domain data, and generate the adjacency graph by calculating a third loss function such that the product of the distance matrix and the adjacency graph is minimized.

In addition, the spatial layer may include a GNN (graph neural network).

In addition, the temporal layer may include at least one of an LSTM (long short-term memory), a transformer, and a TCN (temporal convolutional network).

According to another embodiment of the present invention, a method of processing multivariate time-series sensor data of a multivariate time-series sensor data processing apparatus is provided, the method comprising: acquiring source domain data and target domain data of the multivariate time-series sensor data; classifying the source domain data based on features of a source spatial structure of the source domain data, using a pre-trained artificial neural network; and classifying the target domain data based on features of a target spatial structure of the target domain data, using the artificial neural network; wherein the artificial neural network is pre-trained to dynamically generate an adjacency graph between the source domain data and the target domain data and the target spatial structure, and is pre-trained such that the distribution of the target domain data approaches the distribution of the source domain data based on the adjacency graph.

Herein, the artificial neural network may be pre-trained to generate the source spatial structure and the target spatial structure using the source domain data and the target domain data as input, and to generate the adjacency graph between the source domain data and the target domain data using adjacency matrices of the source spatial structure and the target spatial structure.

In addition, the artificial neural network may be pre-trained to extract the features of the source spatial structure and the features of the target spatial structure using a spatial layer and a temporal layer to learn spatial information and temporal information of the multivariate time-series sensor data.

According to still another embodiment of the present invention, a method of training an artificial neural network for processing multivariate time-series sensor data of a multivariate time-series sensor data processing apparatus is provided, the method comprising: acquiring source domain data and target domain data of the multivariate time-series sensor data; inputting the source domain data and the target domain data to the artificial neural network; training the artificial neural network to generate an adjacency graph between the source domain data and the target domain data using an adjacency matrix of a source spatial structure of the source domain data and a target spatial structure of the target domain data; and training the artificial neural network to extract features of the source spatial structure and features of the target spatial structure using a spatial layer and a temporal layer; wherein the training of the artificial neural network to generate the adjacency graph includes generating the adjacency graph such that the distribution of the target domain data approaches the distribution of the source domain data.

Herein, the source domain data may include labeled data, and the target domain data may not include labeled data.

In addition, the method of training may further include training the artificial neural network to calculate a first loss function that uses the labeled data based on the features of the source spatial structure.

In addition, the method of training may further include training the artificial neural network to calculate a second loss function that uses pseudo-labeled data based on the features of the target spatial structure.

In addition, the method of training may further include training the artificial neural network to calculate a distance matrix between the source domain data and the target domain data, and to calculate a third loss function such that the product of the distance matrix and the adjacency graph is minimized.

According to still further embodiment of the present invention, a non-transitory computer-readable storage medium is provided that stores a computer program, wherein the computer program includes instructions for causing a processor to perform a method of training an artificial neural network for processing multivariate time-series sensor data of a multivariate time-series sensor data processing apparatus, and the method comprises: acquiring source domain data and target domain data of the multivariate time-series sensor data; inputting the source domain data and the target domain data to the artificial neural network; training the artificial neural network to generate an adjacency graph between the source domain data and the target domain data using an adjacency matrix of a source spatial structure of the source domain data and a target spatial structure of the target domain data; and training the artificial neural network to extract features of the source spatial structure and features of the target spatial structure using a spatial layer and a temporal layer; wherein the training of the artificial neural network to generate the adjacency graph includes generating the adjacency graph such that the distribution of the target domain data approaches the distribution of the source domain data.

According to the above aspects of the present invention, by dynamically generating an adjacency graph of MTS sensor data and performing unsupervised domain adaptation (UDA) learning that does not use labeled data in a target domain, it is possible to extract domain-invariant information and implement regularization that prevents a model from overfitting to the distribution of a source domain used during the training process. As a result, embodiments may respond to complex domain distribution shifts related to spatio-temporal characteristics that may occur in MTS data, enabling domain adaptation that considers the multivariate aspect, which is a key feature of the data. For example, embodiments may consider the complex sensor structure of MTS data by introducing an adjacency graph construction module and generating an intra-domain or inter-domain adjacency graph from a dynamic perspective. In addition, an embodiment presents a new loss function that aligns the distribution of a target domain with that of the source domain distribution by considering an inter-domain sensor relationship. The model training method according to an embodiment, which uses a graph construction module and a new loss function, is expected to achieve a statistical learning effect similar to the Wasserstein distance metric at a lower computational cost.

### BRIEF DESCRIPTION OF THE DRAWINGS

FIG. 1 is a block diagram illustrating functions of a multivariate time-series sensor data processing apparatus according to an embodiment of the present invention.

FIG. 2 is a block diagram illustrating detailed functions of a processor in the multivariate time-series sensor data processing apparatus of FIG. 1.

FIG. 3 is a diagram illustrating an overall concept of a multivariate time-series sensor data processing apparatus according to an embodiment of the present invention.

FIG. 4 is a diagram illustrating an example case of adjusting a domain distribution between domain sensors through the adjacency graph generation model of FIG. 3.

FIG. 5 is a diagram illustrating an example of a loss function that is calculated to adjust the domain distribution between sensors of FIG. 4.

FIGS. 6A and 6B are conceptual diagrams illustrating a conventional unsupervised domain adaptation technique and an MTS unsupervised domain adaptation technique.

FIG. 7 is a conceptual diagram illustrating an unsupervised domain adaptation technique to which an MTS sensor data processing technique that dynamically considers an inter-domain sensor relationship is applied according to an embodiment of the present invention.

### DETAILED DESCRIPTION

Advantages and features of embodiments and methods of achieving them will become clear by reference to the embodiments described below in detail with the accompanying drawings. However, the disclosed subject matter is not limited to the embodiments disclosed below but may be implemented in various forms. These embodiments are provided only to complete the disclosure and to fully convey the scope of the invention to those skilled in the art, and the scope of the invention is defined only by the claims.

In describing the embodiments, detailed descriptions of known functions or configurations will be omitted except when actually necessary for explaining the embodiments. The terms described below are defined in consideration of their functions in an embodiment of the present invention, and may vary according to the intentions of a user or operator, or customs. Therefore, the definitions should be made based on the content throughout this specification.

Hereinafter, embodiments of the present invention will be described in detail with reference to the accompanying drawings.

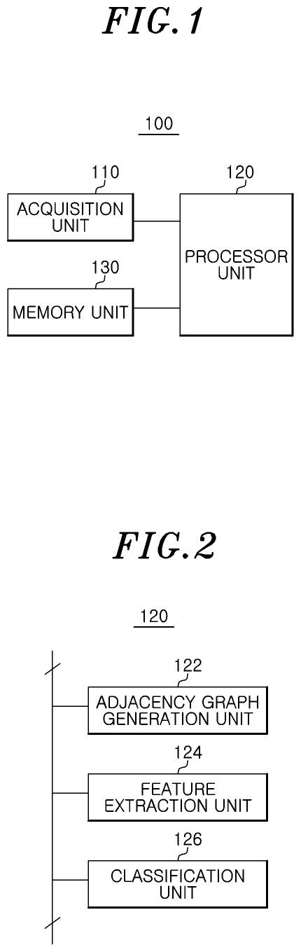

FIG. 1 is a block diagram illustrating functions of a multivariate time-series sensor data processing apparatus 100 according to an embodiment of the present invention.

As shown in FIG. 1, the multivariate time-series sensor data processing apparatus 100 may include an acquisition unit 110, a processor 120, and a memory 130.

The multivariate time-series sensor data processing apparatus 100 is an electronic device for computing processing. In an embodiment of the present invention, the electronic device may include at least one of, for example, a smartphone, an e-book reader, a tablet personal computer, a laptop personal computer, a netbook computer, a desktop computer, a server computer, and a wearable device (e.g., a smart watch, smart glasses, a head-mounted-device (HMD), electronic clothing, an electronic bracelet, an electronic necklace, a smart mirror, etc.). In another embodiment, the electronic device may include at least one of network security equipment, navigation equipment, marine electronic equipment (e.g., a marine navigation device, a gyro compass, etc.), avionics, a vehicle head unit, a point of sales (POS) terminal in a store, and an Internet of Things device. In addition, the electronic device may be equipped with an application for executing various operations for MTS sensor data processing (data acquisition, data processing, data storage, etc.). The application may include, for example, a smartphone application, a personal computer (PC) application, a set-top box (STB) application, a web application, an instant application, etc., and is not limited to a specific application.

In FIG. 1, the acquisition unit 110 may acquire MTS sensor data and classify the acquired MTS sensor data into source domain data and target domain data. Of course, the acquisition unit 110 may also directly acquire the source domain data and the target domain data of the MTS sensor data. Here, the source domain data may include data and labeled data, and the target domain data may include only data without labeled data.

The acquisition unit 110 may include, for example, an interface device or a communication device for connecting an external server or an external database to the multivariate time-series sensor data processing apparatus 100.

The processor 120 may classify the source domain data and the target domain data based on features of a source spatial structure and features of a target spatial structure of the MTS data by executing instructions in the memory 130. To this end, the processor 120 may dynamically generate an adjacency graph between the source domain data and the target domain data and the target spatial structure, and may train an artificial neural network in the memory 130 such that the distribution of the target domain data approaches the distribution of the source domain data based on the generated adjacency graph. The processor 120 may include, for example, a processing device such as a microprocessor, a central processing unit (CPU), a graphic processing unit (GPU), a tensor processing unit (TPU), a processor core, a multiprocessor, an application-specific integrated circuit (ASIC), a field programmable gate array (FPGA), a micro controller unit (MCU), etc., but is not limited thereto. The detailed configuration and function of the processor 120 will be described in detail with reference to FIG. 2.

The memory 130 may include instructions for extracting features of a source spatial structure and features of a target spatial structure from the source domain data and the target domain data using a pre-trained artificial neural network. Any instructions in the memory 130 may be stored in the form of an application, a program, etc., and any stored instruction may be selected and executed by the processor 120. The memory 130 may include, for example, a memory such as a random access memory (RAM) or a read only memory (ROM), and a recording medium such as a local disc or a storage connected via a network (not shown), and is not limited to a specific recording medium in implementing the embodiments of the present invention.

FIG. 2 is a block diagram illustrating detailed functions of the processor 120 in the multivariate time-series sensor data processing apparatus 100 of FIG. 1.

As shown in FIG. 2, the processor 120 may include an adjacency graph generation unit 122, a feature extraction unit 124, and a classification unit 126.

As shown in FIG. 2, the adjacency graph generation unit 122 may train the artificial neural network in the memory 130 to dynamically generate an adjacency graph between the source domain data and the target domain data and the target spatial structure. At this time, the adjacency graph generation unit 122 may train the artificial neural network in the memory 130 such that the distribution of the target domain data approaches the distribution of the source domain data based on the generated adjacency graph.

The feature extraction unit 124 may train the artificial neural network in the memory 130 to extract features of the source spatial structure and features of the target spatial structure from the source domain data and the target domain data.

The classification unit 126 may classify the source domain data based on the features of the source spatial structure and classify the target domain data based on the features of the target spatial structure. At this time, the classification unit 126 may classify the source domain data to calculate a first loss function that uses labeled data based on the features of the source spatial structure, and may classify the target domain data to calculate a second loss function that uses pseudo-labeled data based on the features of the target spatial structure.

Therefore, the processor 120 may calculate a distance matrix between the source domain data and the target domain data, and may process the artificial neural network in the memory 130 to generate an adjacency graph by calculating a third loss function such that the product of the distance matrix and the adjacency graph is minimized.

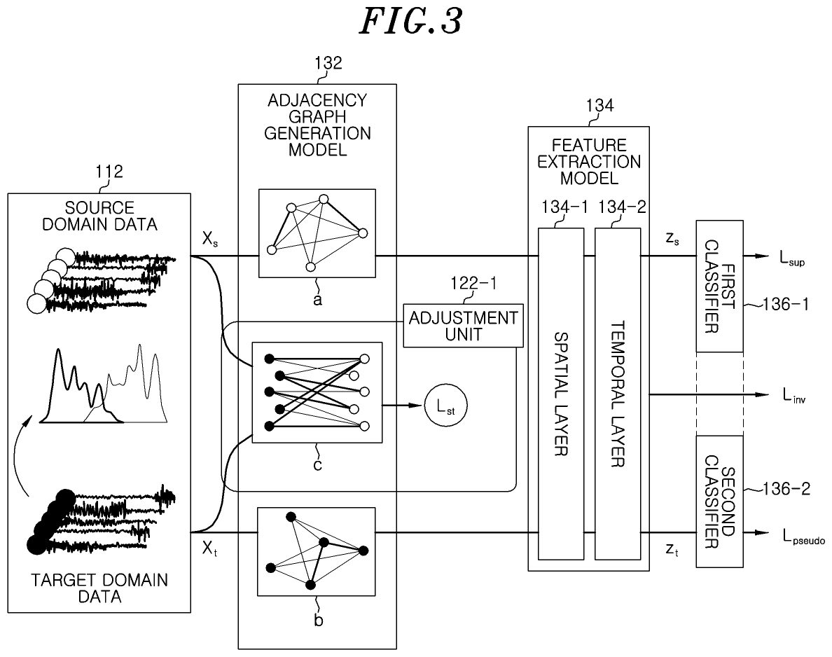

FIG. 3 is a diagram illustrating an overall concept of the multivariate time-series sensor data processing apparatus 100 according to an embodiment of the present invention.

MTS sensor data 112 acquired by the multivariate time-series sensor data processing apparatus 100 may include source domain data and target domain data.

The arrow starting from the MTS sensor data 112 on the far left of FIG. 3 indicates the flow in which the source domain data and the target domain data are used for model training, and schematically shows a structure in which a graph and embeddings constructed from the data are used for inter-domain sensor adjustment and an additional loss function related to the domain adaptation methodology proposed in the present invention.

The source domain data and the target domain data may be separately input to an adjacency graph generation model 132. Here, the input source domain data and target domain data may be denoted as Xₛ,Xₜ respectively.

Source domain data Xₛ passes through the adjacency graph generation model 132 and a feature extraction model 134 and is output as an embedding result zₛ, and this embedding result zₛ is used to calculate a cross-entropy loss function Lₒᵤₜ (the first loss function) that uses actual ground truth labels by utilizing a first classifier 136-1.

Target domain data Xₜ also passes through the adjacency graph generation model 132 and the feature extraction model 134 and is output as an embedding result zₜ and this embedding result zₛ is used to calculate a cross-entropy loss function L_{pseudo} (the second loss function) that uses pseudo labels by utilizing a second classifier 136-2. The loss function L_{pseudo} that uses pseudo labels will be described in detail below.

In FIG. 3, the classification unit 126 is described as being divided into the first classifier 136-1 and the second classifier 136-2, but this is an example, and the first classifier 136-1 and the second classifier 136-2 may be utilized as the same classifier 126.

Meanwhile, as shown in FIG. 3, two additional loss functions exist in the present invention in which the source domain data and the target domain data are used together for calculation.

These correspond to the spatial shift loss function Lₛₜ, which utilizes the inter-domain graph as can be seen in the vertical middle part of FIG. 3, and the global invariance learning function Lᵢₙᵥ, which utilizes embeddings extracted via the feature extraction unit 124. A detailed description of each function will be supplemented below.

The adjacency graph generation model 132 of FIG. 3 was introduced to consider the multivariate sensor structure of MTS data from the perspective of feature learning and domain adaptation by constructing an adjacency graph within the source domain data and the target domain data, and between the source domain data and the target domain data.

The adjacency graph output by the adjacency graph generation model 132 may be defined by the following [Equation 1].

$$g ( {X}_{1} , {X}_{2} ) = σ ( ( {W}_{O} {X}_{1} ) {( {W}_{O} {X}_{2} )}^{T} . \qquad [ Equation 1 ]$$

In [Equation 1], W denotes a learnable weight matrix, and the function σ used here has a characteristic of making the elements of the matrix real values between 0 and 1 and making the sum of each row and each column equal to 1. This characteristic makes the resulting adjacency matrix continuous, thereby allowing for a more detailed capture of complex sensor relationship structures. In [Equation 1], both X₁ and X₂ may be Xₛ or Xₜ as needed for graph construction.

In FIG. 3, the structure of the adjacency graph generated within each domain is denoted as a source spatial structure (a) and a target spatial structure (b), and the source spatial structure (a) and the target spatial structure (b) are utilized as an adjacency matrix of the spatial layer 134-1 of the feature extraction model 134. Each adjacency matrix Aₛ,Aₜ generated within the source domain data and the target domain data may be expressed by the following [Equation 2].

$$\begin{matrix}{A}_{s} = g ( {X}_{{s}^{′}} , {X}_{s} ) , \\ {A}_{t} = g ( {X}_{{t}^{′}} , {X}_{t} )\end{matrix} \qquad [ Equation 2 ]$$

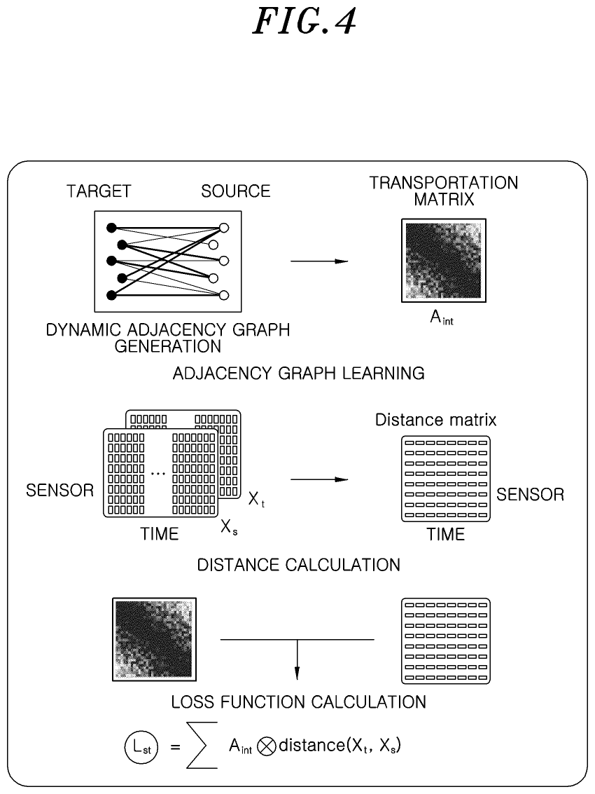

An inter-domain sensor adjacency graph (c) is generated to utilize the sensor relationship between the source domain data and the target domain data, and is utilized in the inter-domain sensor adjustment methodology, which is a domain adaptation technique of FIG. 4 below. The adjacency matrix Aᵢₙₜ generated between the source domain data and the target domain data may be calculated by the following [Equation 3].

$${A}_{int} = g ( {X}_{t} , {X}_{n} ) \qquad [ Equation 3 ]$$

The feature extraction model 134 was introduced to effectively learn the spatial/temporal feature structure of MTS data.

The feature extraction model 134 may be composed of a spatial layer 134-1 and a temporal layer 134-2, and each layer (134-1, 134-2) is used to learn spatial information and temporal information of MTS data.

In one embodiment, the spatial layer 134-1 may include a GNN (graph neural network) and perform an aggregation process as in the following [Equation 4].

$$H = {AWX}_{1} \qquad [ Equation 4 ]$$

In another embodiment, the temporal layer 134-2 may include at least one artificial neural network from among an LSTM (long short-term memory), a transformer, and a TCN (temporal convolutional network), and various other temporal information learning neural networks may be utilized.

FIG. 4 is a diagram illustrating an example case of calculating a third loss function Lₛₜ through an adjustment unit 122-1 of FIG. 3 to adjust the domain distribution between domain sensors through the adjacency graph generation model 132 of FIG. 3.

As shown in FIG. 4, an adjacency matrix of a learnable inter-domain adjacency graph Aᵢₙₜ obtained through the adjacency graph generation model 132 is adopted as a transportation matrix. By directly using the inter-domain sensor information in the transportation matrix in this way, it is intended to solve the data distribution difference between the source domain data and the target domain data from the perspective of a multivariate sensor structure.

A distance matrix is derived by calculating the distance between the inputs of the source domain data and the target domain data. At this time, the distance calculation is based on, for example, the Euclidean distance, and the form of the distance matrix is the same as the transportation matrix because both the rows and columns correspond to the number of sensors.

The calculation of the new spatial shift loss function Lₛₜ (the third loss function) may be learned, for example, in a direction that reduces the sum of the matrix elements of the resulting matrix after performing a Hadamard product on the transportation matrix and the distance matrix. The third loss function may be expressed by the following [Equation 5].

$${L}_{st} = \sum {A}_{int} ⊗ distance ( {X}_{t} , {X}_{n} ) \qquad [ Equation 5 ]$$

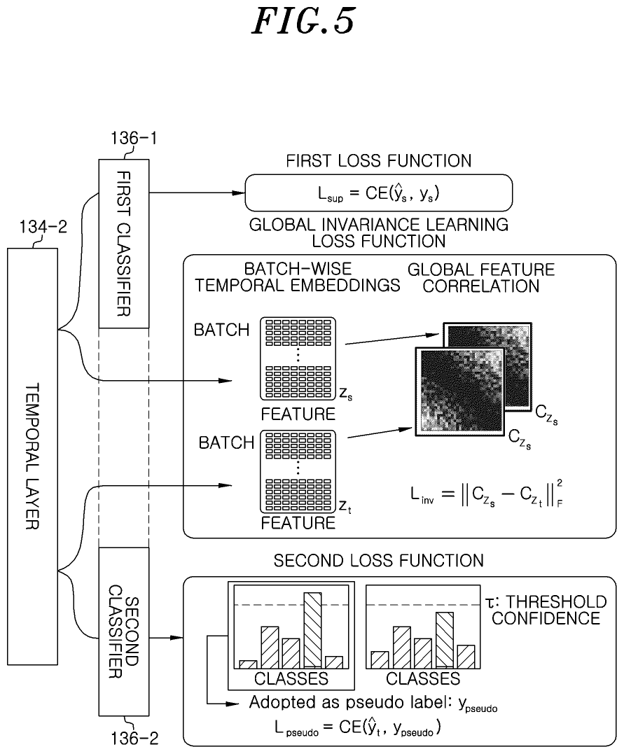

FIG. 5 is a diagram illustrating an example of loss functions calculated to adjust the domain distribution between sensors of FIG. 4.

As shown in FIG. 5, it illustrates how the first loss function (supervised learning loss function), the second loss function Lᵢₙᵥ (pseudo-labeling loss function), and the global invariance learning loss function are calculated as the embedding results extracted via the temporal layer 134-2 of the feature extraction model 134.

The first loss function Lₛₒᵣ is a cross-entropy loss function that uses embeddings obtained from the source domain data and ground truth labels.

The calculation process of the global invariance learning loss function Lᵢₙᵥ may be referred to in the box labeled “Global Learning Loss Function” in FIG. 5.

It may be confirmed that for the second loss function L_{pseudo}, only cases with a confidence level above a certain threshold are adopted as pseudo labels and participate in the calculation of the loss function. The second loss function shares the same classifier as the one used for the calculation of the supervised learning loss function, and is also a cross-entropy loss function.

The global invariance learning function of FIG. 5, to learn a distribution that does not change between the two domains, may adopt a global invariant feature learning function similar to, for example, the “Deep CORAL (Sun & Saenko, 2016)” methodology.

In addition, since the pseudo-labeling loss function may create a representation with high confidence with the help of the spatial shift loss function and the global invariance learning function, pseudo-labeling may be performed using that representation to calculate the cross-entropy loss function.

Model training may be performed with the proposed domain adaptation methodology, additional loss functions, the feature extraction model, and the learning flow.

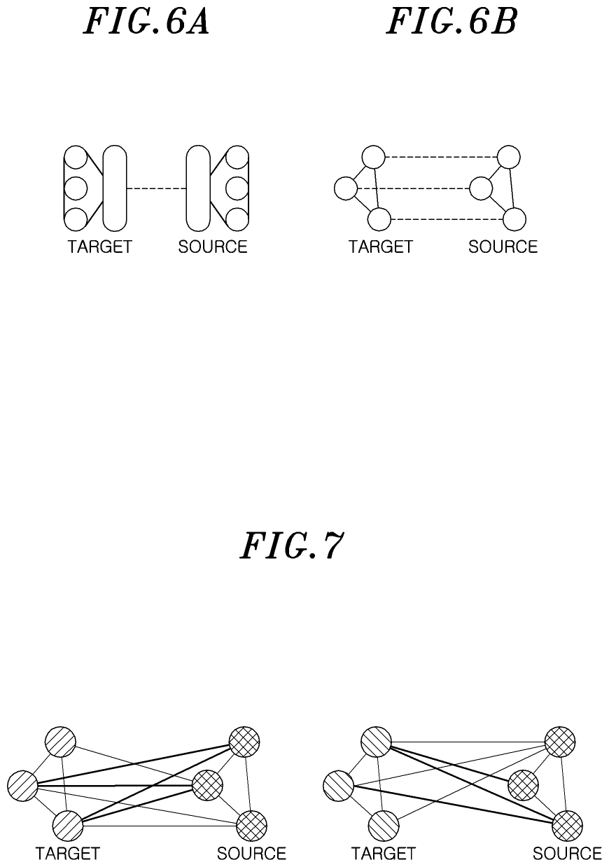

FIG. 6 is a conceptual diagram illustrating a conventional unsupervised domain adaptation technique and an MTS unsupervised domain adaptation technique.

Domain adaptation methods focus on reducing the distribution difference between domains to improve performance in a target domain.

Conventional methodologies may be broadly divided into adversarial training, statistical learning, and self-supervision.

The left diagram of FIG. 6 illustrates a conventional UDA. Conventional domain generalization methods often merge inputs from multiple sensors and treat them as the input of a single sensor, even when dealing with MTS data.

As shown in the right diagram of FIG. 6, there are a few MTS-UDA methods that consider a multi-sensor structure, but because they assume a fixed one-to-one relationship that trains the same sensor to have similar characteristics in the inter-domain sensor relationship, there is a possibility that complex inter-domain sensor relationships may be overlooked.

In the case of such a simple approach to a multi-sensor structure, it may be difficult to effectively respond to the inter-domain distribution shift caused by the complex spatio-temporal characteristics of MTS sensor data.

FIG. 7 is a conceptual diagram illustrating an unsupervised domain adaptation technique to which an MTS sensor data processing technique that dynamically considers an inter-domain sensor relationship is applied according to an embodiment of the present invention.

Compared to FIG. 6, it may be seen that in the unsupervised domain adaptation technique to which the MTS sensor data processing technique according to the embodiment of the present invention is applied, the distribution of the target domain has been transformed to be almost similar to the distribution of the source domain.

Through this, an embodiment may effectively respond to domain variations according to the unique spatio-temporal characteristics of MTS data and may dynamically consider complex sensor relationships between domains.

### Experimental Example

In the domain adaptation methodology proposed in an embodiment, loss functions were calculated with a feature extraction model and a learning flow, and model training was performed by applying a backpropagation technique. The experimental results of the model according to an embodiment and a control model are as shown in [Table 1] and [Table 2] below. The datasets used for model training included, for example, Opportunity HAR, Nina5-18, Nina5-53, and SD-gesture, and the model according to an embodiment will be referred to as IDSA (inter-domain sensor alignment).

TABLE 1

| Models | 1 → 2 | 1 → 3 | 1 → 4 | 2 → 1 | 2 → 3 | 2 → 4 | 3 → 1 | 3 → 2 | 3 → 4 | 4 → 1 | 4 → 2 | 4 → 3 | Avg. |
|---|---|---|---|---|---|---|---|---|---|---|---|---|---|
| Deep Coral | 81.56 | 68.94 | 72.92 | 84.53 | 81.06 | 64.08 | 81.09 | 65.08 | 64.08 | 74.79 | 39.11 | 53.11 | 69.19 |
| DANN | 76.82 | 68.01 | 64.13 | 79.94 | 70.81 | 56.84 | 81.09 | 68.44 | 72.22 | 74.5 | 41.75 | 59.01 | 67.79 |
| CDAN | 81.01 | 53.42 | 75.34 | 82.52 | 77.95 | 57.1 | 75.93 | 77.09 | 72.92 | 79.66 | 37.71 | 51.55 | 68.52 |
| CoDATS | 80.45 | 66.77 | 74.53 | 85.67 | 78.57 | 71.58 | 84.24 | 62.29 | 70.51 | 87.97 | 73.46 | 50.31 | 73.86 |
| AdvSKM | 83.52 | 76.09 | 71.31 | 82.81 | 72.98 | 53.35 | 77.08 | 59.5 | 52.55 | 58.74 | 49.44 | 38.2 | 64.63 |
| CLUDA | 84.08 | 84.78 | 81.5 | 85.1 | 82.3 | 75.87 | 62.75 | 77.93 | 83.38 | 86.25 | 83.52 | 84.47 | 80.99 |
| SEA | 79.61 | 62.42 | 74.26 | 81.09 | 72.36 | 65.95 | 78.22 | 75.97 | 70.24 | 74.5 | 60.05 | 57.85 | 71.04 |
| IDSA | 85.47 | 79.81 | 87.67 | 92.84 | 89.13 | 85.52 | 86.82 | 87.71 | 77.75 | 92.55 | 76.82 | 77.64 | 84.98 |

TABLE 2

| [symbol] ₛ | [symbol] ₜ | [symbol] ₜ | Model | | Nina5-18 | Nina5-53 | SD-gesture |
|---|---|---|---|---|---|---|---|
| ◯ | ◯ | ◯ | Supervised | SimpleAtt | 83.42 | 80.26 | 87.54 |
| | | | | Slow Fusion | 81.29 | 80.93 | 83.80 |
| | | | | TCN | 80.40 | 76.76 | 72.79 |
| | | | | STCN-GR | 78.56 | 75.12 | 69.04 |
| | | | | 2SRNN | 84.01 | 80.52 | 88.44 |
| | | | | FCSTGNN | 85.00 | 80.64 | 76.87 |
| | | | | TS-GAC | 86.64 | 81.03 | 73.62 |
| ◯ | ◯ | X | UDA | Deep Coral | 73.74 | 71.23 | 37.43 |
| | | | | CDAN | 73.58 | 71.48 | 40.94 |
| | | | | CoDATS | 71.19 | 71.61 | 42.41 |
| | | | | AdvSKM | 72.23 | 71.34 | 44.41 |
| | | | | CLUDA | 69.44 | 75.65 | 52.57 |
| | | | | SEA | 75.71 | 75.72 | 52.86 |
| | | | | IDSA | 85.56 | 80.20 | 87.37 |

As may be seen from [Table 1] and [Table 2], the IDSA model according to an embodiment showed overall improved data classification performance compared to other baseline models.

According to an embodiment as described above, by dynamically generating an adjacency graph of MTS sensor data and performing unsupervised domain adaptation (UDA) learning that does not use labeled data in a target domain, it is possible to extract domain-invariant information and implement regularization that prevents a model from overfitting to the distribution of a source domain used during the training process. As a result, an embodiment may respond to complex domain distribution shifts related to spatio-temporal characteristics that may occur in MTS data, enabling domain adaptation that considers the multivariate aspect, which is a key feature of the data. For example, an embodiment may consider the complex sensor structure of MTS data by introducing an adjacency graph construction module and generating an intra-domain or inter-domain adjacency graph from a dynamic perspective. In addition, an embodiment presents a new loss function that shifts the distribution of a target domain to be similar to a source domain distribution by considering an inter-domain sensor relationship. The model training method according to an embodiment, which uses a graph construction module and a new loss function, is expected to achieve a statistical learning effect similar to the Wasserstein distance metric at a lower cost.

Meanwhile, the combinations of each block in the attached block diagrams and each step in the flowcharts may also be performed by computer program instructions. These computer program instructions may be loaded into a processor of a general-purpose computer, a special-purpose computer, or other programmable data processing equipment, so that the instructions executed by the processor of the computer or other programmable data processing equipment create means for performing the functions described in each block of the block diagram.

These computer program instructions may also be stored in a computer-usable or computer-readable recording medium (or memory) that may direct a computer or other programmable data processing equipment to implement functions in a specific way, so that the instructions stored in the computer-usable or computer-readable recording medium (or memory) may also produce an article of manufacture containing instruction means for performing the functions described in each block of the block diagram.

In addition, the computer program instructions may also be loaded onto a computer or other programmable data processing equipment, so that a series of operational steps are performed on the computer or other programmable data processing equipment to create a computer-executed process, and the instructions that execute on the computer or other programmable data processing equipment may also provide steps for executing the functions described in each block of the block diagram.

In addition, each block may represent a part of a module, segment, or code including at least one or more executable instructions for executing specified logical function(s). It should also be noted that in some alternative embodiments, the functions mentioned in the blocks may occur out of order. For example, two blocks shown in succession may in fact be executed substantially simultaneously, or the blocks may sometimes be executed in reverse order, depending on the corresponding function.

What is claimed is:

1. An apparatus for processing multivariate time-series sensor data, the apparatus comprising:
an acquisition unit configured to acquire multivariate time-series sensor data and to classify the multivariate time-series sensor data into source domain data and target domain data;
a memory including instructions for extracting features of a source spatial structure and features of a target spatial structure from the source domain data and the target domain data using a pre-trained artificial neural network; and
a processor configured to, by executing the instructions, classify the source domain data based on the features of the source spatial structure and classify the target domain data based on the features of the target spatial structure;
wherein the artificial neural network is pre-trained to dynamically generate an adjacency graph between the source domain data and the target domain data and the target spatial structure, and is pre-trained such that a distribution of the target domain data approaches a distribution of the source domain data based on the adjacency graph.

2. The apparatus of claim 1, wherein the artificial neural network includes:
an adjacency graph generation model pre-trained to generate the source spatial structure and the target spatial structure using the source domain data and the target domain data as input, and to generate the adjacency graph using an adjacency matrix of the source spatial structure and the target spatial structure; and
a feature extraction model pre-trained to extract the features of the source spatial structure and the features of the target spatial structure using a spatial layer and a temporal layer to learn spatial information and temporal information of the multivariate time-series sensor data.

3. The apparatus of claim 1, wherein the source domain data includes labeled data, and the target domain data does not include labeled data.

4. The apparatus of claim 3, wherein the processor classifies the source domain data to calculate a first loss function that uses the labeled data based on the features of the source spatial structure.

5. The apparatus of claim 3, wherein the processor classifies the target domain data to calculate a second loss function that uses pseudo-labeled data based on the features of the target spatial structure.

6. The apparatus of claim 3, wherein the processor calculates a distance matrix between the source domain data and the target domain data, and generates the adjacency graph by calculating a third loss function such that a product of the distance matrix and the adjacency graph is minimized.

7. The apparatus of claim 2, wherein the spatial layer includes a GNN (graph neural network).

8. The apparatus of claim 2, wherein the temporal layer includes at least one of an LSTM (long short-term memory), a transformer, and a TCN (temporal convolutional network).

9. A method for processing multivariate time-series sensor data to be performed by a multivariate time-series sensor data processing apparatus, the method comprising:
acquiring source domain data and target domain data of multivariate time-series sensor data;
classifying, using a pre-trained artificial neural network, the source domain data based on features of a source spatial structure of the source domain data; and
classifying, using the artificial neural network, the target domain data based on features of a target spatial structure of the target domain data;
wherein the artificial neural network is pre-trained to dynamically generate an adjacency graph between the source domain data and the target domain data and the target spatial structure, and is pre-trained such that a distribution of the target domain data approaches a distribution of the source domain data based on the adjacency graph.

10. The method of claim 9, wherein the artificial neural network is pre-trained to generate the source spatial structure and the target spatial structure using the source domain data and the target domain data as input, and to generate the adjacency graph between the source domain data and the target domain data using an adjacency matrix of the source spatial structure and the target spatial structure.

11. The method of claim 9, wherein the artificial neural network is pre-trained to extract the features of the source spatial structure and the features of the target spatial structure using a spatial layer and a temporal layer to learn spatial information and temporal information of the multivariate time-series sensor data.

12. The method of claim 9, wherein the source domain data includes labeled data, and the target domain data does not include labeled data.

13. The method of claim 12, wherein in the classifying the source domain data, classifying the source domain data to calculate a first loss function that uses the labeled data based on the features of the source spatial structure.

14. The method of claim 12, wherein in the classifying the target domain data, classifying the target domain data to calculate a second loss function that uses pseudo-labeled data based on the features of the target spatial structure.

15. The method of claim 12, wherein the artificial neural network calculates a distance matrix between the source domain data and the target domain data, and generates the adjacency graph by calculating a third loss function such that a product of the distance matrix and the adjacency graph is minimized.

16. The method of claim 11, wherein the spatial layer includes a GNN.

17. The method of claim 11, wherein the temporal layer includes at least one of an LSTM, a transformer, and a TCN.

18. A method for training an artificial neural network for processing multivariate time-series sensor data of a multivariate time-series sensor data processing apparatus, the method comprising:
acquiring source domain data and target domain data of multivariate time-series sensor data;
inputting the source domain data and the target domain data to the artificial neural network;
training the artificial neural network to generate an adjacency graph between the source domain data and the target domain data using an adjacency matrix of a source spatial structure of the source domain data and a target spatial structure of the target domain data; and
training the artificial neural network to extract features of the source spatial structure and features of the target spatial structure using a spatial layer and a temporal layer;
wherein the training of the artificial neural network to generate the adjacency graph comprises generating the adjacency graph such that a distribution of the target domain data approaches a distribution of the source domain data.

19. The method of claim 18, wherein the source domain data includes labeled data, and the target domain data does not include labeled data.

20. The method of claim 18, wherein the artificial neural network calculates a distance matrix between the source domain data and the target domain data, and generates the adjacency graph by calculating a third loss function such that a product of the distance matrix and the adjacency graph is minimized.
